(19) United States
(12) Patent Application Publication
(10) Pub. No.: US 2010/0321715 A1
(43) Pub. Date: Dec. 23, 2010

(54) METHODS AND STRUCTURE FOR PRESERVING NODE ORDER WHEN STORING XML DATA IN A KEY-VALUE DATA STRUCTURE

(76) Inventor: David A. Williams, Los Gates, CA (US)

Correspondence Address: DUFT BORNSEN & FISHMAN, LLP, 1526 SPRUCE STREET, SUITE 302, BOULDER, CO, 80302, US

(21) Appl. No.: 12/488,902

(22) Filed: Jun. 22, 2009

(51) Int. Cl. G06F 3/12

(52) U.S. Cl. 358/1.13

(57) ABSTRACT

Methods and apparatus for processing XML data in a printing system by translating the XML data into corresponding entries in a key-value data structure that includes information regarding the original order of the XML nodes in the XML data. In one exemplary embodiment, XML nodes in a JDF job ticket are processed by a parser program in the printing system to translate the XML node into entries of a Postscript dictionary data structure. A key value in each entry encodes the ordinal position of the corresponding printing parameter in the JDF job ticket.

### BACKGROUND

1. Field of the Invention

The invention relates generally to processing of eXtensible Markup Language (XML) data/documents and more specifically relates to processing XML data, such as Job Definition Format (JDF) job tickets, in a printing environment so as to retain ordering information relevant to the proper processing of the received XML data when stored in a key-value pair data structure.

2. Discussion of Related Art

XML documents (also referred to herein as “XML data”) are used to encoded data and relationships among the represented data in a standardized, extensible format. Many computer and communication applications have used XML encoding to represent data in a standardized yet flexible and extensible manner. One exemplary application of using XML data entails encoding print job tickets used in printing of print jobs.

In many printing environments, including print shops (large and small) as well as production printing and even smaller workgroup environments, it is generally known to create JDF information describing the processing required to print a particular print job. JDF information is encoded as an XML document. JDF is a widely adopted standard specification for providing information (printing parameters, layout parameters, finishing parameters, etc.) relating to processing of a print job. The JDF information is typically contained in an object/file referred to as a “job ticket” and is associated with the print data for the print job by entries in the job ticket. A JDF job ticket includes any number of JDF elements required to specify printing parameters associated with the printing of a particular job. Exemplary of such printing parameters are: one or more resource locators identifying content for the material to be printed, rendering parameters indicating options for rendering various types of objects associated with a print job, layout options indicating, for example, n-up, duplex, and other available print options, media parameters for printing (e.g., paper size, weight, color, etc.), etc. The JDF standards are published by CIP4 (a trade organization), are well known to those of ordinary skill in the art, and are readily available at www.cip4.org.

In general, JDF elements (encoded as a sequence of XML nodes are defined in terms of a hierarchical tree such that various parameters related to printing of print jobs are grouped into associated, logical branches of the tree of possible parameters and options. The tree has a common root and branches are associated with certain enumerated groupings of related parameters that may be specified by a user/application in creating a job ticket.

In some printing environments, a print server processes the JDF job ticket and associated print data to prepare the final document format for transmission to the printing system. In other printing enterprises, the JDF job ticket and the associated print job data are both sent directly to the printing system for processing. A JDF job ticket interpreter/processor running within the printing system may then process the JDF directives and the associated print data to generate the desired output of the print job.

In processing of a JDF job ticket, it is important that the JDF statements/elements be processed in the order in which they are received. Some JDF options/directives may be specified in multiple ways and, depending on the manner or order of their expression, may indicate different scope of applicability or even a different semantic altogether.

When using a program within the printing system (i.e., in the printer controller) to parse an XML text file into an in-memory data structure, it is natural to select data structures provided by the programming language of the printer controller language which facilitate a hierarchical organization. In some cases, this may be a data structure which does not preserve the order in which elements are defined. One example of this is the dictionary data structure in the PostScript language. A Postscript dictionary is a set of key-value pairs, where the key is generally a name string and the value may be any object, including another dictionary. This allows for a hierarchical organization, because child objects may be represented by sub-dictionaries. This approach preserves the parent-child order, but does not preserve sibling order, because a dictionary does not preserve information about the order in which its key-value pairs were inserted.

Processing capabilities for processing JDF job tickets within a printing system are limited as compared to general purpose workstations and server systems. For example, the JDF interpreter/processor may be implemented as a “program” written in an interpretive language operable within the printing controller of the printing system. Postscript is an example of such an interpretive programming language that may be used to implement JDF job ticket interpretation/processing. Though Postscript is a powerful programming language, it is a challenge to retain the ordering information associated with the elements in a received JDF job ticket when processing the job ticket in the Postscript based JDF interpreter.

Thus it is an ongoing challenge to correctly and efficiently process JDF job tickets and associated print data in a programming language operable within the printing system.

### SUMMARY

The present invention solves the above and other problems, thereby advancing the state of the useful arts, by providing methods and associated structure for processing XML data in a printing system using a programming language that supports key-value pair data structures while maintaining the original ordering of the XML nodes. In particular, features and aspects hereof are adapted to process a JDF job ticket by entering data into a key-value data structure (such as a Postscript dictionary data structure) in such a manner as to retain the ordering of the original JDF elements in the job ticket.

One aspect hereof provides a method operable in a printing system controller for processing XML data associated with a print job. The method includes receiving XML data in a first order wherein the XML data includes a plurality of XML nodes. The method then processes each XML node in the XML data. The processing of each XML node further includes parsing the XML node to identify a print parameter associated with the print job or another XML node. Responsive to identifying a print parameter, the method then includes storing the information related to the print parameter in an entry of a key-value pair data structure. A key value field of the entry indicates the ordinal position of the XML node in the first order and a value field of the entry indicates the print parameter. Responsive to identifying a child XML node of the XML node, recursively processing the child XML node as above. The method then processes each entry in the key-value pair data structure in an order determined by the ordinal position in the key value field of each entry to generate output for the print job in accordance with the printing parameters in the value field of each entry.

Another aspect hereof provides a method operable in a printer controller of a printing system for processing XML data in a JDF job ticket and for processing an associated print job. The method includes receiving the JDF job ticket and associated print job data the JDF job ticket specifying printing parameters encoded as XML nodes. The method then translates the XML nodes in the JDF job ticket into corresponding entries in a Postscript dictionary data structure. The entries in the Postscript dictionary data structure include ordinal values indicating the original order of the elements in the JDF job ticket and include print job parameters specified in the elements of the JDF job ticket. The method then processes the print job data using the print job parameters specified in the Postscript dictionary data structure to output the print job. The processing uses the print job parameters in the order specified by the ordinal values in the entries of the Postscript dictionary data structure.

Yet another aspect hereof provides a printing system that includes a marking engine and a printer controller coupled with the marking engine. The printer controller is adapted to receive a JDF job ticket and associated print job data. The printer controller further includes a memory for storing a key-value data structure having a plurality of entries, each entry storing a key value field and an associated value field. The printer controller also includes a job ticket parser coupled with the memory and adapted to identify a sequence of XML nodes in a first order within the JDF job ticket. Each XML node includes a print parameter name and a print parameter value. The job ticket processor is further adapted to store the present value of a monotonically increasing value in the key value field of an entry of the key-value data structure and further adapted to store the print parameter name and the print parameter value as the corresponding value field of the entry. The printer controller also includes a print job processor coupled with the memory and adapted to process the print job data in accordance with the print parameter names and print parameter values stored in entries of the key-value data structure such that the entries are processed in the first order in accordance with the key value fields of the entries.

### BRIEF DESCRIPTION OF THE DRAWINGS

The same reference number represents the same element or same type of element on all drawings.

FIG. 1 is a block diagram of an exemplary system enhanced in accordance with features and aspects hereof to parse XML data received with a print job to store print parameters therein in a key-value data structure for later use in processing the print job.

FIG. 2 is a block diagram of an exemplary print controller enhanced in accordance with features and aspects hereof to parse XML data of a JDF job ticket received with a print job to store print parameters therein in a Postscript dictionary data structure for later use in processing the print job.

FIG. 3 is a block diagram of exemplary XML data parsed/translated into a key-value data structure in accordance with features and aspects hereof.

FIGS. 4 and 5 are flowcharts describing exemplary methods in accordance with features and aspects hereof to parsed/translate XML data providing printing parameters for an associated print job into a key-value data structure in accordance with features and aspects hereof.

### DETAILED DESCRIPTION OF THE DRAWINGS

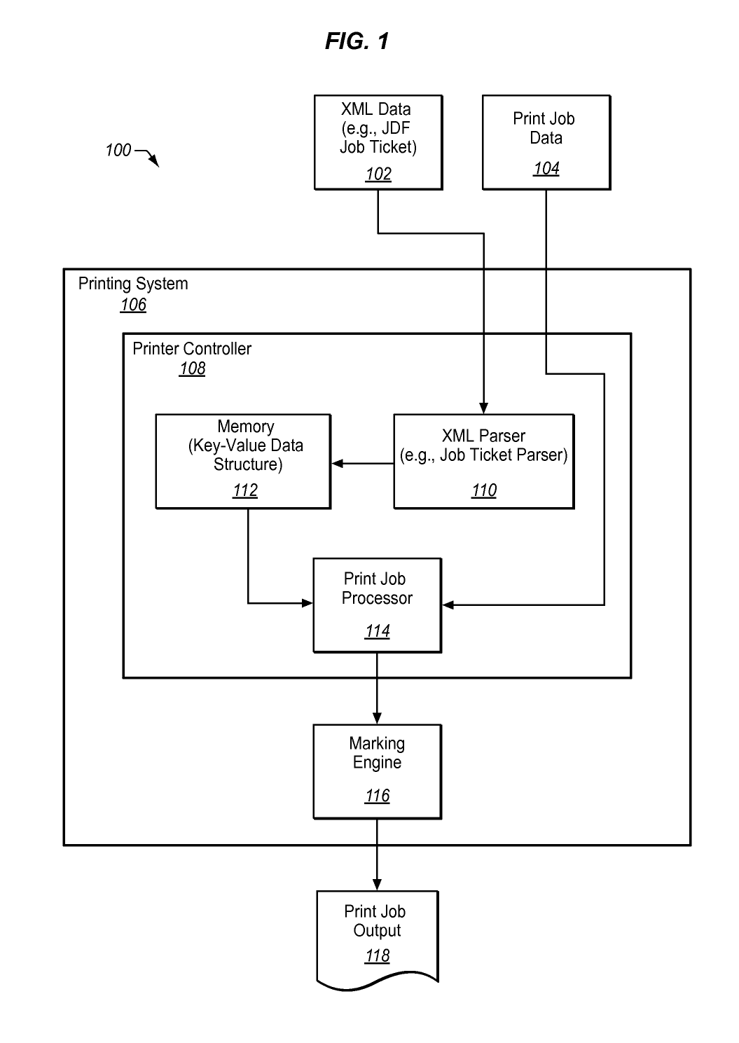

FIGS. 1 through 5 and the following description depict specific exemplary embodiments of the present invention to teach those skilled in the art how to make and use the invention. For the purpose of this teaching, some conventional aspects of the invention have been simplified or omitted. Those skilled in the art will appreciate variations from these embodiments that fall within the scope of the present invention. Those skilled in the art will appreciate that the features described below can be combined in various ways to form multiple variations of the present invention. As a result, the invention is not limited to the specific embodiments described below, but only by the claims and their equivalents.

FIG. 1 is a block diagram of an exemplary system 100 enhanced in accordance with features and aspects hereof to provide a printing system adapted for receiving XML data associated with a print job and processing or translating the received XML data to generate a corresponding key-value data structure representing information in the XML nodes of the XML data. Printing system 106 may include a printer controller 108 coupled to receive XML data 102 and associated print job data 104 from an appropriate source. In some exemplary embodiments the source of the XML data 102 and the print job data 104 may be an application program operable on a computing system or server coupled to printing system 106. In other embodiments, the XML data 102 and print job data 104 may be stored in a storage system associated with printing system 106 and retrieved therefrom for processing.

Printer controller 108 may be any suitable computing device and/or electronic device adapted for receiving XML data 102 and associated print job data 104. Printer controller 108 may include XML parser 110 adapted to receive the XML data 102 and adapted to parse the XML data to identify individual XML nodes within the XML data 102. The XML nodes in XML data 102 may specify printing parameters to be applied to the printing of print job data 104. Controller 108 may include memory 112 for storing a key-value data structure in which the printing parameters are stored. Memory 112 may be any suitable random access memory component including, for example, RAM, DRAM, SDRAM, nonvolatile memory, etc.

For each identified XML node, XML parser 110 generates a corresponding entry in the key-value data structure stored in memory 112. The entries so generated and stored in the key-value data structure are structured so as to retain the original sequence order of the XML nodes identified by XML parser 110 in its processing of XML data 102. In general, XML data 102 may specify a number of parameters defined in a hierarchical structure of the XML nodes. The order in which parameters are specified in XML data 102 is often relevant to appropriate interpretation and processing of the printing parameters contained therein. Thus, the key-value data structure stored in memory 112 includes information regarding the original order of the sequence of XML nodes processed by XML parser 110. The order may be indicated by, for example, storing the present value of a monotonically increasing value as an ordinal index value in a key field of each entry of the key-value data structure as entries are added.

Printer controller 108 may also include print job processor 114 adapted to receive the print job data 104 and further adapted to retrieve the entries of the key-value data structure stored in memory 112 as generated by XML parser 110. Print job processor 114 is further adapted to process the print job data 104 in accordance with printing parameters stored in the key-value data structure to generate a corresponding sequence of page images representing the printed pages of the print job data 104 and formatted in accordance with the printing parameters. The generated page images are then applied to marketing engine 116 which, in turn, generates the final printed job output 118.

In one exemplary embodiment, XML data 102 may be a JDF job ticket specifying various formatting and layout parameters associated with the print job data 104. Where XML data 102 is a JDF job ticket, XML parser 110 comprises a JDF job ticket parser to identify XML nodes specifying JDF printing parameters to be applied to the print job data 104. Thus the key-value data structure stored in memory 112 stores the JDF printing parameters as the value of entries, each entry associated with a corresponding key value. As noted above, the key-value data structure stored in memory 112 stores information regarding the original order of the sequence of XML nodes specifying JDF printing parameters. Since the order of specification of JDF printing parameters has an effect on the interpretation and application of the printing parameters, this stored original order information is utilized when print job processor 114 processes the specified printing parameters and associated processing of print job data 104.

In another exemplary embodiment, XML parser 110 and print job processor 114 may be implemented as Postscript programs processed by a Postscript interpreter functioning operable within printer controller 108. In such an embodiment, the key-value data structure stored in memory 112 may be, for example, a Postscript dictionary data structure, a Postscript array data structure, other Postscript data structures, or various combinations of Postscript data structures.

Those of ordinary skill in the art will readily recognize numerous additional and equivalent structures and functions present within printing system 106 and printer controller 108. Such additional and equivalent structures and functions are omitted herein for simplicity and brevity of this discussion.

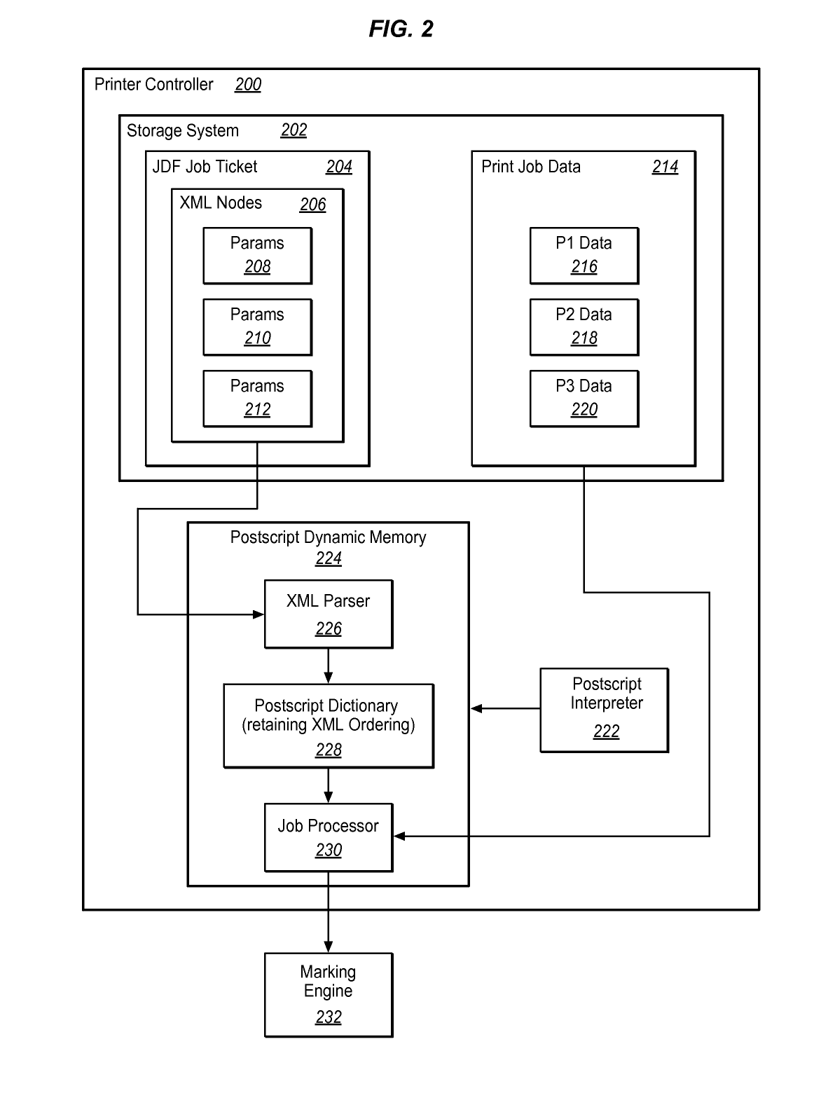

FIG. 2 is a block diagram of an exemplary printer controller 200 in accordance with features and aspects hereof to provide for translation of XML nodes in a JDF job ticket for processing of an associated print job. Printer controller 200 may include storage system 202 adapted for storing a JDF job ticket 204 and associated print job data 214. Storage system 202 may comprise any suitable memory or mass storage device capable of storing JDF job ticket 204 and print job data 214 including, for example, RAM of various types and disk or other mass storage devices of various types. JDF job ticket 204 includes a sequence of XML nodes 206 including, for example, parameters 208, 210, and 212. Those of ordinary skill in the art will readily recognize that the parameters specified in the sequence of XML nodes 206 may be subdivided or grouped by particular pages or groups of pages or may be applicable to all pages of the entire associated print job data 214. The grouping and scope of particular parameters specified in the sequence of XML nodes 206 of JDF job ticket 204 are well known to those of ordinary skill in the art as design choices in accordance with the JDF standards. Print job data 214 in storage system 202 may include print data for a sequence of page images to be generated as the final print job output. P1 data 216, P2 data 218, and P3 data 220 represent data for corresponding pages 1, 2, and 3 of print job data 214. Those of ordinary skill in the art will readily recognize that any number of pages may be specified within print job data 214 limited only by the capabilities of the printing system and the page description languages (PDLs) employed in the printing system, if any. Further, those of ordinary skill in the art will readily recognize that the pages (216, 218, and 220) of print job data 214 may be encoded in any of a variety of printer control languages and/or page description languages including, for example, PCL, Postscript, PDF, etc. These and other exemplary printer control languages and page description languages are well known to those of ordinary skill in the art.

Printer controller 200 also includes Postscript interpreter 222 operable to process a print job represented by JDF job ticket 204 and associated print job data 214. In particular, Postscript interpreter 222 processes Postscript language statements or commands representing programs operable within printer controller 200. Postscript dynamic memory 224 may store programs encoded in the Postscript interpreted language such as an XML parser 226 and job processor 230. Postscript dynamic memory 224 may be any suitable memory device for storing Postscript interpretive commands and related data. Such memory devices may include, for example, RAM, DRAM, SDRAM, nonvolatile RAM, etc.

XML parser 226 may be a Postscript program adapted to retrieve XML data from the sequence of XML nodes 206 in storage system 202 and adapted to translate the retrieved XML nodes into corresponding entries in Postscript dictionary 228. Postscript dictionary data structures are an example of key-value data structures implementable within the Postscript interpreted language. In particular, XML parser 226 generates entries in Postscript dictionary 228 such that the entries are encoded with key values including information regarding the original order of the sequence of XML nodes 206 now translated and represented by data in Postscript dictionary 228. Since the sequence of XML nodes 206 specified within JDF job ticket 204 is relevant to the interpretation and application of the printing parameters specified therein, the original ordering information is retained in the entries of the Postscript dictionary generated by XML parser 226. Those of ordinary skill in the art will also recognize a variety of other Postscript data structures that may be used for representing the information stored in the script dictionary 228. For example, Postscript array data structures may be similarly used to implement a key-value data structure and associated operations.

Job processor 230 may a Postscript program interpreted by Postscript interpreter 222 and operable to generate page images corresponding to the print job data 214 under format and layout control of the printing parameters specified in Postscript dictionary 228. In particular, job processor 230 retrieves the print job data 214 for each of the specified pages (e.g., 216 through 220) and applies the retrieved printing parameters in the proper order from Postscript dictionary 228. Based on the printing parameters retrieved from Postscript dictionary 228 interpreted and applied in the proper original ordering of the XML nodes 206, job processor 230 generates page images and applies the page images to marking engine 232 to generate the printed output corresponding to the print job data 214 in formatted in accordance with the printing parameters specified in JDF job ticket 204.

Those of ordinary skill in the art will readily recognize numerous additional and equivalent structures and functions present within printing controller 200. Such additional and equivalent structures and functions are omitted herein for simplicity and brevity of this discussion.

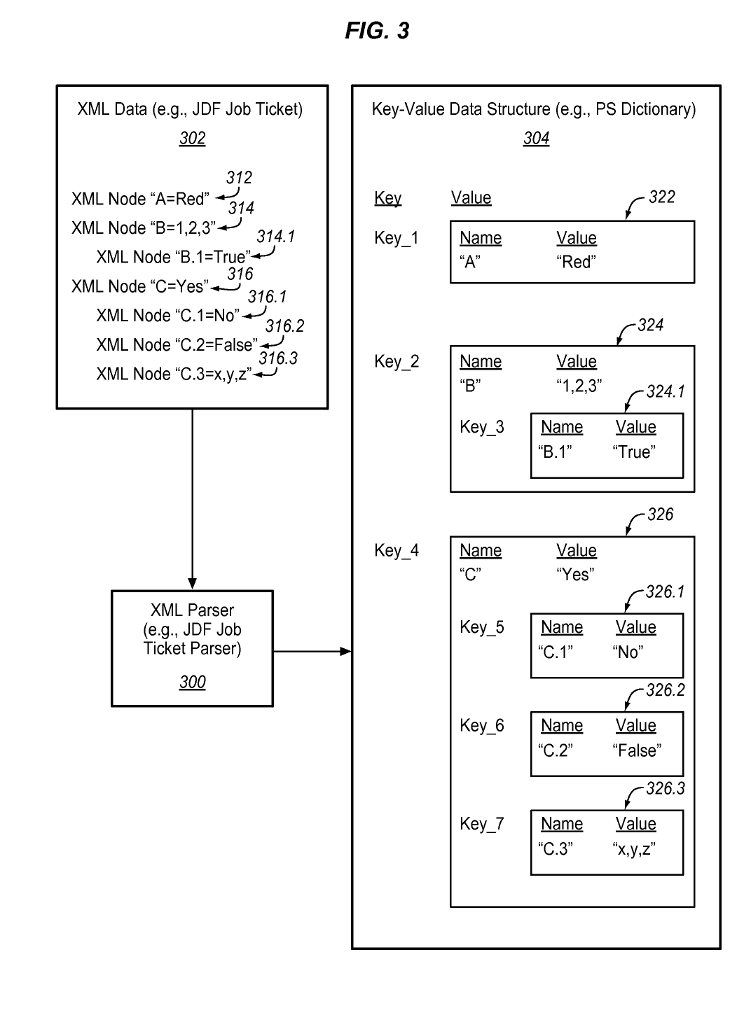

FIG. 3 is a block diagram depicting an exemplary XML data 302 (e.g., a JDF job ticket) processed by an XML parser 300 (e.g., a JDF job ticket parser) to generate a corresponding key-value data structure 304 (e.g., a Postscript dictionary data structure). XML data 302 shows an exemplary sequence of XML nodes arranged in a hierarchical manner. A first XML node 312 signifies a parameter “A” being set to a value of “Red”. XML node 314 indicates a printing parameter “B” set to a sequence of values “1,2,3”. XML node 314 is a parent node that hierarchically includes a child node 314.1 indicating a parameter “B.1” being set to a value of “True”. XML node 316 indicates yet another parent node having a parameter “C” set to the value “Yes”. Child nodes 316.1 through 316.3 of parent node 316 indicate, respectively, printing parameters “C.1” set to a value of “No”, “C.2” set to a value of “False”, and “C.3” set to a value of “x,y,z”.

XML parser 300 processes the various XML nodes 312 through 316.3 in the order in which they are provided in the XML data 102 (e.g., as provided in the JDF job ticket). The sequence of XML nodes are translated into corresponding entries in key-value data structure 304 (e.g., a Postscript dictionary or other Postscript data structure.). The key-value settings include a key field value for each entry. The key field value indicates or represents the ordinal sequence of the values as originally processed in the JDF job ticket regardless of the physical order in which entries are stored in the key-value data structure 304. A first entry includes a key value of “Key_1”. The corresponding value field 322 of the first entry is a data structure such as a Postscript array or another Postscript dictionary that includes a name field indicating that the parameter is named “A” and a value field indicating that the value of the parameter is “Red”. Another entry in the key-value data structure 304 indicates a key value of “Key_2” and has a corresponding value field 324 in this case having multiple entries because node 314 is a parent XML node having a child XML node. The value field 324 (again represented as a Postscript array, dictionary or other suitable Postscript data structure) indicates in a first entry the name of the parameter as “B” and a corresponding value of “1,2,3”. A second entry in the value field 324 indicates represents the child node of the corresponding parent node and includes a name field indicating another key value “Key_3”. The value field 324.1 corresponding to the child's key ordinal value is yet another Postscript array or dictionary data structure (or other suitable data structure) indicating that the name of the corresponding parameter is “B1” and the corresponding value is “True”.

Yet another parent XML node is represented by an entry in key-value data structure 304 wherein the key value is “Key_4” and the corresponding value field 326 indicates that the name of the corresponding printing parameter is “C” and its value is “Yes”. Since the associated XML parent node has three child nodes, the value field 326 of the parent node also includes three additional entries corresponding to the three related child XML nodes. A first such entry indicates a name field representing the key “Key_5” and a corresponding value field 326.1 representing the print parameter name as “C.1” and the value as “No”. Another entry in the value field 326 indicates the name as a key index value of “Key_6” and a corresponding value field 326.2 representing the parameter name as “C.2” and a corresponding value of “False”. A third entry additional entry in the value field 326 indicates the name as another key field value of “Key_7” and a corresponding value field 326.3 representing the corresponding print parameter name as “C.3” and its corresponding value as “x,y,z.”. Regardless of the physical order in which the entries of structure 304 are stored, the key values (e.g., Key_1 through Key_7) store information used to retain the original ordering of XML nodes in XML data 302.

The key-value data structure 304 exemplified in FIG. 3 is more readily applicable by the job processor of the associated printing system in that the various printing parameters are represented in a Postscript dictionary data structure. The key values “Key_1” through “Key_7” are used by the job processor to assure retrieval of the parameters in an order corresponding to the original order in which the sequence of XML nodes were defined in the corresponding XML data 302 (e.g., the corresponding JDF job ticket). As shown in FIG. 3, the value field entries 322 through 326.3 may be represented as Postscript dictionary data structures (e.g., hierarchically embedded one within another). Those of ordinary skill in the art will also recognize that Postscript array data structures may be utilized for implementing the key-value data structure 304 as well as other Postscript data structures. Still further, those of ordinary skill in the art will recognize that other programming languages (i.e., other than Postscript) may be utilized to implement features and aspects hereof so long as they provide similar richness and flexibility in the programmable data structures utilized. For example, Java or JavaScript may provide similar data structures and thus Java and JavaScript programming languages could be utilized for implementing the XML parser 300 and the key-value data structure 304 generated by operation of such an XML parser 300. Further, those of ordinary skill in the art will readily recognize that the particular parameter names and parameter values shown in FIG. 3 as well as the number of such parameters specified in the JDF job ticket are intended merely as exemplary. Any number of desired printing parameters may be specified in the XML data of a JDF job ticket and any number of corresponding entries in the key-value data structure 304 may be provided to represent the printing parameters while retaining information identifying the original order in which the parameters are provided in the original XML data 302.

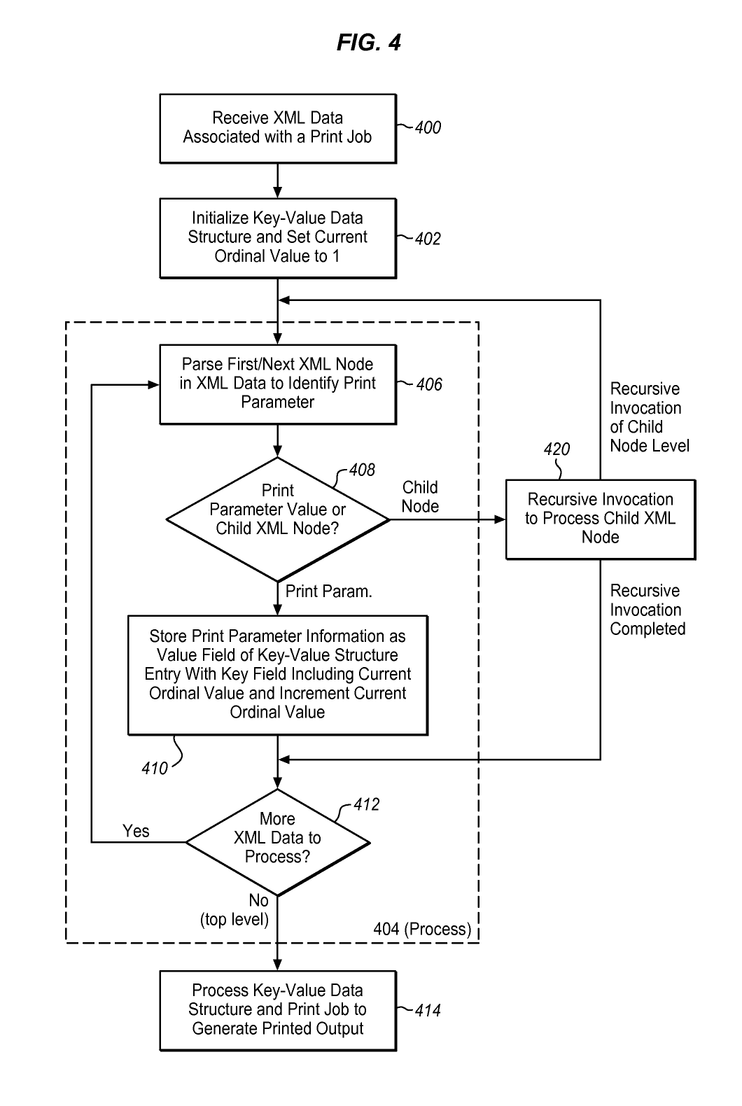

FIG. 4 is a flowchart describing an exemplary method in accordance with features and aspects hereof for processing XML data and associated print job data in such a manner as to translate the XML data into corresponding key-value entries while retaining the original ordering of the XML nodes specified in the XML data. The method of FIG. 4 may be performed within a controller of a printing system or any other suitable device adapted for processing such XML data and associated print job data. In particular, in one exemplary embodiment, the method of FIG. 4 may be implemented as a Postscript program interpreted by an appropriate Postscript interpreter operable within a printing system controller or other suitable computational apparatus.

Step 400 receives the XML data (e.g., the JDF job ticket) and the associated print job data. The XML data and associated print job data may be received from any suitable source including, for example, an attached host system or server or may be retrieved from a storage system associated with a printing system controller performing the method of FIG. 4. Step 402 initializes a key-value data structure and also initializes a current ordinal index value. Initialization of a key-value data structure may simply entail defining or instantiating a suitable data structure such as a Postscript dictionary and/or other Postscript data structures. The ordinal index value is initialized to 1 and is utilized in generating key values to be stored in the key field of entries stored in the key-value data structure as XML nodes are processed.

Steps 406 through 412 are collectively referred to as step 404 and represent the processing of each of the XML nodes specified in a sequence of XML nodes in the received XML data (e.g., the JDF job ticket). In particular, step 406 parses the first or next XML node in the sequence of XML nodes in the received XML data to identify printing parameters specified therein. In parsing an XML node, it is first determined whether the node specifies a print parameter or specifies another XML node (e.g., a child XML node hierarchically specified within a parent XML node. Step 408 then determines whether the XML node parsed by step 406 represents a print parameter or a child XML node. If the parsed XML node represents a print parameter, step 410 next stores the parameter information as the value field in a new entry of the key-value data structure. The key field is set to a value including the current value of the ordinal index and the ordinal index value is incremented. Thus the new entry in the key-value data structure includes a key field value indicating the ordinal position of this node in the original sequence of the received XML data (e.g., the ordinal position of this XML node in a JDF job ticket). Step 412 then determines whether more data remains to be parsed in the received XML data. If so, processing continues looping back to element step 406 to parse and further process a next XML node of the sequence of XML nodes in the received XML data. If no further data remains to be processed in the received XML data (and if the current processing of step 404 is the completion of all received XML data as opposed to a recursive invocation of step 404 as discussed below) then processing continues at step 414 to process the completed key-value data structure and associated print job by generating printed output in accordance with the specified printing parameters. Processing of step 414 assures that the printing parameters are retrieved from the key-value data structure using the key values that include an ordinal index value representing the original order of the parameters as specified in the received XML data (e.g., the order as specified in the JDF job ticket). Thus regardless of the physical ordering of the entries in the key-value data structure, the job processing of step 414 may retrieve the printing parameters from these entries in the original order in which they were encoded in the XML data.

If step 408 determines that an XML node just parsed by step 406 represents a child XML node of the current higher-level parent XML node, step 420 is operable to recursively invoke the processing of step 404 (e.g., steps 406 through 412) to process the child node (and recursively process children of the child, etc.). Upon completion of the recursive processing of the child node (including any hierarchically deeper child nodes), processing returns to the earlier invocation of the processing of step 404 corresponding to an earlier parent XML node.

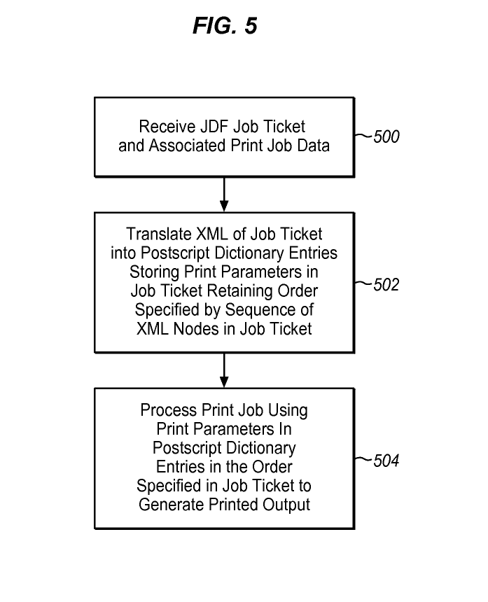

FIG. 5 is a flowchart describing another exemplary method in accordance with features and aspects hereof to process a JDF job ticket and its associated print job data in a printing system. The method of FIG. 5 may be performed within a controller of a printing system or any other suitable device adapted for processing such XML data and associated print job data. Step 500 receives a JDF job ticket and its associated print job data. Step 502 translates the sequence of XML nodes in the JDF job ticket into corresponding entries in a Postscript dictionary data structure or other suitable Postscript data structures. The translation performed by step 502 uses an ordinal index value or other suitable indicia to store information regarding the sequence of the XML nodes as originally received in the JDF job ticket. Step 504 then processes the print job data using the printing parameters encoded within the Postscript dictionary to generate the output formatted as specified by the printing parameters of the JDF job ticket (as translated into the Postscript dictionary data structure).

Those of ordinary skill in the art will readily recognize numerous additional and equivalent steps in the processing of the methods of FIGS. 4 and 5. Such additional and equivalent steps are omitted herein for simplicity and brevity of this discussion.

Although specific embodiments were described herein, the scope of the invention is not limited to those specific embodiments. The scope of the invention is defined by the following claims and any equivalents thereof.

We claim:

1. A method operable in a printing system controller for processing XML data associated with a print job, the method comprising:
receiving XML data in a first order wherein the XML data includes a plurality of XML nodes;
processing each XML node in the XML data where processing of each XML node further comprises:
parsing the XML node to identify a print parameter associated with the print job or another XML node;
responsive to identifying a print parameter, storing the information related to the print parameter in an entry of a key-value pair data structure where a key value field of the entry indicates the ordinal position of the XML node in the first order and where a value field of the entry indicates the print parameter; and
responsive to identifying a child XML node of the XML node, recursively processing said child XML node; and
processing each entry in the key-value pair data structure in an order determined by the ordinal position in the key value field of each entry to generate output for the print job in accordance with the printing parameters in the value field of each entry.

2. The method of claim 1
wherein the XML data is a JDF job ticket.

3. The method of claim 1
wherein the printing system controller includes a Postscript interpreter, and
wherein the step of processing each XML node is performed by the Postscript interpreter.

4. The method of claim 3
wherein the step of storing information uses a Postscript dictionary data structure and further comprises:
generating the key value so as to include a current value of a monotonically increasing index value;
incrementing the index value;
storing the generated key value as the key value field in an entry of the Postscript dictionary structure; and
storing the name of the XML node and the print parameter as the value field of the entry.

5. The method of claim 4
wherein the step of storing the name and the print parameter further comprises:
storing a Postscript array data structure as the value field of the entry where the array data structure includes the name as an entry of the array data structure and includes the print parameter as another entry of the array data structure.

6. The method of claim 4
wherein the step of storing the name and the print parameter further comprises:
storing another entry in another Postscript dictionary data structure as the value field of the entry where said another entry includes the name as the key value field of said another entry and includes the print parameter as the value field of said another entry.

7. A method operable in a printer controller of a printing system for processing XML data in a JDF job ticket and for processing an associated print job, the method comprising:
receiving the JDF job ticket and associated print job data the JDF job ticket specifying printing parameters encoded as XML nodes;
translating XML nodes in the JDF job ticket into corresponding entries in a Postscript dictionary data structure wherein the entries in the Postscript dictionary data structure include ordinal values indicating the original order of the elements in the JDF job ticket and include print job parameters specified in the elements of the JDF job ticket; and
processing the print job data using the print job parameters specified in the Postscript dictionary data structure to output the print job wherein the processing uses the print job parameters in the order specified by the ordinal values in the entries of the Postscript dictionary data structure.

8. The method of claim 7
wherein the step of translating further comprises:
a) identifying a parameter name and a parameter value in a parent XML node;
b) adding an entry to the Postscript dictionary data structure where the entry includes a key value field and an associated value field, wherein the key value field includes the current value of a monotonically increasing value as the ordinal value, and wherein the associated value field includes the parameter name and the parameter value;
c) incrementing the monotonically increasing value;
d) determining whether the parent XML node includes any child XML nodes;
e) responsive to a determination that the XML node includes a child XML node, performing the additional steps of:
f) recursively repeating steps a) through e) for each child XML node of the parent XML node; and
f) repeating the steps a) through e) for each parent XML node.

9. A printing system comprising:
a marking engine; and
a printer controller coupled with the marking engine and adapted to receive a JDF job ticket and associated print job data,
the printer controller further comprising:
a memory for storing a key-value data structure having a plurality of entries, each entry storing a key value field and an associated value field;
a job ticket parser coupled with the memory and adapted to identify a sequence of XML nodes in a first order within the JDF job ticket, each XML node including a print parameter name and a print parameter value, the job ticket processor further adapted to store the present value of a monotonically increasing value in the key value field of an entry of the key-value data structure and further adapted to store the print parameter name and the print parameter value as the corresponding value field of the entry;
a print job processor coupled with the memory and adapted to process the print job data in accordance with the print parameter names and print parameter values stored in entries of the key-value data structure such that the entries are processed in the first order in accordance with the key value fields of the entries.

10. The system of claim 9
wherein the sequence of XML nodes comprises at least one parent XML node and at least one child XML node associated with each of the parent XML nodes, and
wherein the job ticket processor is further adapted to recursively process each child XML node of each parent XML node.

11. The system of claim 10
wherein the value field of each entry of the key-value data structure is an array data type comprising a plurality of fields.

12. The system of claim 9 further comprising:
a Postscript interpreter,
wherein the job ticket parser is a Postscript program executed by the Postscript interpreter.

13. The system of claim 12
wherein the key-value data structure stored in the memory is a Postscript dictionary.

14. The system of claim 13
wherein a key field of an entry in the Postscript dictionary includes the present value of a monotonically increasing value.

15. The system of claim 14
wherein a value field of an entry in the Postscript dictionary includes a printing parameter name and includes a printing parameter value.

16. The system of claim 15
wherein the printing parameter value in the Postscript dictionary includes a second Postscript dictionary that includes a printing parameter name and includes a printing parameter value.
